(19) United States
(12) Patent Application Publication
(10) Pub. No.: US 2023/0114563 A1
(43) Pub. Date: Apr. 13, 2023

(54) SOLIDS JETTING RETROFIT

(71) Applicant: FMC Technologies, Inc., Houston, TX (US)

(72) Inventor: Sander Baaren, Houston, TX (US)

(73) Assignee: FMC Technologies, Inc., Houston, TX (US)

(21) Appl. No.: 17/905,434

(22) PCT Filed: Mar. 4, 2021
(86) PCT No.: PCT/US2021/020795

§ 371 Date: Sep. 1, 2022

Related U.S. Application Data
(60) Provisional application No. 62/986,119, filed on Mar. 6, 2020.

(51) Int. Cl. B01D 21/24

(52) U.S. Cl. CPC B01D 21/2472

(57) ABSTRACT

A method of retrofitting an existing separator pressure vessel (100) with a solids removal system (118) includes installing a support structure (122) in the separator pressure vessel (100), adjusting a size of the support structure (122) within the separator pressure vessel to frictionally engage contact surfaces of the support structure with an inner surface of the separator pressure vessel or a surface of a component installed in the separator pressure vessel, installing a supply header (124) and a suction header (126) on the support structure in the separator pressure vessel, coupling a jetting nozzle (128) or a cyclonic device to the supply header, coupling the supply header to an inlet nozzle (160a) extending from an interior of the separator pressure vessel to an exterior of the separator pressure vessel; and coupling the return header to an outlet nozzle (160b) from an interior of the separator pressure vessel to an exterior of the separator pressure vessel.

### BACKGROUND

During oil production operations, the produced fluid stream may include a combination of oil, gas, and/or water. Vessel gravity based separators are often used for primary separation of gas and liquid (two phase) or gas, oil, and water (three phase). For example, a two-phase separator may be used to separate a fluid stream having two substances and a three-phase separator may be used to separate a fluid stream having three substances. Two- and three-phase separators are generally vessels that may be positioned horizontally or vertically and rely the earth's gravity to separate the different fluids based on their respective densities. The vessel volume provides residence time for the fluids allowing the gravity separation process to take place. The fluid residence time refers to the quantity of a substance (e.g., water) in a vessel or reservoir divided by the rate of loss or addition of the substance (e.g., water). One example of a three-phase separator is a free water knockout (FWKO) drum or vessel. A FWKO vessel is a pressure vessel that may be a two-phase or three-phase separator used to separate water from production fluids. A FWKO drum may receive flow from one or more oil or gas wells. Another example of a gravity based vessel separator is a test separator. During production from multiple wells, a test separator may be used to separate fluids from one particular well so that the production rates of gas, water, and oil can be measured separately. Test separators are typically used in conjunction with a FWKO vessel. One well flows through the test separator so that its production from each phase can be measured, while the production fluids from the remaining wells may be routed to a larger FWKO. Test separators are generally similar to a FWKO vessel in terms of functionality, but may be smaller in size and therefore may include different components. There are more types of separators and configurations possible outside of the two examples provided here. These examples are highlighted for the sole purpose of providing context and background to the invention.

Production fluids are flowed into a vessel separator and using residence time and internal components of the vessel separator, the separation of two or three substances by gravity through their respective density differences may be enabled and enhanced. In general, a three-phase separator includes a large drum or pressure vessel with a fluid inlet, a water outlet, an oil outlet, and a gas outlet. A weir is disposed inside the vessel and separates the vessel into two compartments. Fluid enters the vessel through the fluid inlet. The fluid settles in the vessel on one side of the weir. As the fluid settles, gases may escape into an upper area of the vessel, the vapor space, and may exit through the gas outlet. Over time, the water and oil separate. The water may exit through the water outlet located in the first compartment on a first side of the weir. As the height of the liquid layer near the bottom of the separator increases, due to the addition of additional production oil or water, oil spills over the weir into the second compartment on a second side of the weir. Oil then exits the vessel separator through the oil outlet.

In certain applications, solid particles are entrained in the fluid stream coming into a gravity based separator. For example, sand may come out of the reservoir of an oil or gas well. Also, for unconventional oil or gas wells, solid particles are injected as part of the well completion process (fracking). During first production of the well, a certain percentage of these solid particles (frack proppant) is entrained in the production fluids and will therefore enter the primary separator(s). If the primary separator(s) are gravity based vessel separators, all or a certain percentage of the solids settle by gravity and accumulate on the bottom of the vessel. Solids accumulations in the vessel separator over time causes issues that affect the function of a gravity based vessel separator. For example, the volume occupied by the solids is taken away from volume required to allow the oil-water gravity separation process. Consequently, significant amounts of oil may be entrained in the water exiting the water outlet or vice versa. Another possibility is that so much of the volume is taken up by the accumulated solids that the solids entrained in the fluids no longer separate by gravity but exit through the water outlet. When this happens, the solids cause mechanical erosion to the piping, valves and instruments that are downstream of the water outlet. In many cases, the only way to remove solids from a gravity based vessel separator is to take the vessel offline and manually remove the solids. Taking the vessel separator offline includes stopping fluid production form the well(s), depressurizing the vessel, and venting any gases therein. A manway is then opened and operation personnel must manually remove the solids from the vessel. Once the solids are removed the manway must be closed, the air must be purged from the vessel, and the vessel must be pressured up before production can commence. This overall process is labor intensive, operation personnel is exposed to significant health and safety risks, and because the process takes a significant amount of time to complete, there is significant deferred production from the wells.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method of retrofitting an existing separator pressure vessel with a solids removal system, the method comprising installing a support structure in the separator pressure vessel; adjusting a size of the support structure within the separator pressure vessel to frictionally engage contact surfaces of the support structure with an inner surface of the separator pressure vessel or a surface of a component installed in the separator pressure vessel; installing a supply header and a suction header on the support structure in the separator pressure vessel; coupling a jetting nozzle or a cyclonic device to the supply header; coupling the supply header to an inlet nozzle extending from an interior of the separator pressure vessel to an exterior of the separator pressure vessel; and coupling the return header to an outlet nozzle from an interior of the separator pressure vessel to an exterior of the separator pressure vessel.

In another aspect, embodiments disclosed herein relate to a solids removal system comprising a support structure; a supply header coupled to the support structure; a jetting nozzle in fluid communication with the supply header; a return header coupled to the support structure; and a flange, the flange comprising an inlet nozzle extending through the manway cover, a first end of the inlet nozzle configured to couple with a first end of the supply header; and an outlet nozzle extending through the manway cover, a first end of the outlet nozzle configured to couple with a first end of the suction header.

In another aspect, embodiments disclosed herein relate to a separator pressure vessel system comprising a weir extending up from a bottom of the separator pressure vessel; an adjustable support structure removably disposed within the separator pressure vessel on a first side of the weir, the support structure comprising at least two contact surfaces configured to frictionally engage an inner surface of the separator pressure vessel or a component installed in the separator pressure vessel; a supply header coupled to the adjustable support structure; a jetting nozzle or cyclonic device in fluid communication with the supply header; a suction header disposed in the separator pressure vessel and coupled to the support structure; an inlet nozzle extending from an interior of the separator pressure vessel to an exterior of the separator pressure vessel, wherein the inlet nozzle is coupled to the supply header; and an outlet nozzle extending from an interior of the separator pressure vessel to an exterior of the separator pressure vessel, wherein the outlet nozzle is coupled to the return header.

Other aspects and advantages will be apparent from the following description and the appended claims.

### BRIEF DESCRIPTION OF THE DRAWINGS

FIG. 1 is a schematic of a side view of horizontal vessel separator with a solids removal system in accordance with embodiments disclosed herein.

FIG. 2 is a schematic of a side view of vertical vessel separator with a solids removal system in accordance with embodiments disclosed herein.

FIG. 3 is schematic of an end view of a vessel separator with a solids removal system in accordance with embodiments disclosed herein.

FIG. 4 is a perspective view of an assembled support structure, supply header, return header, and jetting nozzles in accordance with embodiments disclosed herein.

FIG. 5 is a perspective view of fluid flow through a solids removal system in a vessel separator in accordance with embodiments disclosed herein.

FIG. 6 is perspective, partial cut-away view of a vessel separator with a solids removal system in accordance with embodiments disclosed herein.

FIG. 7 is a partial perspective view of a vessel separator with a solids removal system in accordance with embodiments disclosed herein.

FIG. 8 is a perspective view of a manway cover for a vessel separator in accordance with embodiments disclosed herein.

FIG. 9 is a process diagram of a solids removal system for a vessel separator in accordance with embodiments disclosed herein.

FIG. 10 is a process diagram of a solids removal system for a test separator in accordance with embodiments disclosed herein.

### DETAILED DESCRIPTION

Embodiments of the present disclosure are described below in detail with reference to the accompanying figures. Like elements in the various figures may be denoted by like reference numerals for consistency. Further, in the following detailed description, numerous specific details are set forth in order to provide a more thorough understanding of the claimed subject matter. However, it will be apparent to one having ordinary skill in the art that the embodiments described may be practiced without these specific details. In other instances, well-known features have not been described in detail to avoid unnecessarily complicating the description.

Embodiments disclosed herein generally relate to systems and methods for removal of solids accumulations in vessel separators. More specifically, embodiments disclosed herein relate to solids removal systems that may be installed in existing vessel separators even if there are no provisions for such a system or in new vessel separators. A method for retrofitting an existing vessel separator with a solids removal system in accordance with embodiments is also disclosed.

Specifically, in one or more embodiments, an existing vessel separator may be a pressure vessel formed and certified to meet certain standards (e.g., ASME Boiler & Pressure Vessel Code (BPVC)) to ensure its safe operational use at a specified design pressure and design temperature. Modifications to the physical structure of a pressure vessel (e.g., welding components to the vessel, adding new openings or nozzles through the vessel wall, mechanical fasteners to the vessel wall, etc.) or changes to operating temperatures or pressures outside the originally specified operating conditions requires recertification of the pressure vessel, which is often a lengthy, time-consuming process. Embodiment disclosed herein provide a method for retrofitting an existing vessel separator with a solids removal system without modifying the pressure vessel, and therefore does not require the vessel separator to be recertified.

In accordance with one or more embodiments, a vessel separator having a solids removal system in accordance with embodiments disclosed herein may be cleaned (i.e., solids removed) without depressurizing the vessel separator. Specifically, a solids removal system in accordance with the present disclosure allows for periodic or continuous solids removal from a vessel separator without the time consuming and labor intensive method traditionally required of depressurizing a vessel, opening the vessel, and manually cleaning out the solids accumulated in the bottom of the vessel. Although embodiments disclosed herein describe a solids removal system, a person of ordinary skill in the art will appreciate that a solids removal system as described herein may be used to remove any particulate or solid matter accumulated within the vessel separator without departing from the scope of embodiments disclosed. Further, while embodiments disclosed herein may refer to a FWKO drum or a test separator, the present application is equally applicable to any type of gravity based or cyclonic separator aimed to separate two or more fluid substances.

More specifically, in one or more embodiments, a solids removal system includes an adjustable support structure for installation in a vessel separator, a supply header for providing a flow of fluid into the vessel separator, and a least one return header for removing a fluidized solids (i.e., solids suspended in a fluid such as water) from the vessel. The adjustable support structure is configured to be installed and secured within a new or existing vessel separator such that the support structure is not fastened to the vessel separator by mechanical fasteners, welding, bonding, or any other means that would require modification to the vessel separator itself. The support structure is installed within the vessel separator and provides a base on which the supply header and the return header may be secured within the vessel separator.

In accordance with one or more embodiments of the present disclosure, the solids removal system also includes at least one jetting nozzle or cyclonic device coupled to and in fluid communication with the supply header for providing a jetted fluid to the vessel separator to fluidize the solids contained therein. In some embodiments, one or more additional flow lines may be coupled to the supply header and coupled to the support structure. The one or more flow lines may extend along a length of the separator vessel. The at least one jetting nozzle may be coupled to the one or more flow lines so that fluid supplied to the vessel separator flows through the supply header, into the one or more flow lines, and out the at least one jetting nozzle to provide a jetted fluid to an inner surface of the vessel separator.

Embodiments disclosed herein also provide a specially designed flange (manway cover) configured to couple to a manway of a new or existing vessel separator and to allow for fluid to be provided therethrough into the supply header and out from the return header. In other words, a manway cover in accordance with embodiments disclosed herein allows the addition of additional nozzles to a pressure vessel required for a solids removal system, without having to make any modifications to the pressure vessel, thus avoiding the requirement for re-certification. These additional nozzles allow for fluids to be pumped into and out of a pressurized vessel separator without the need to depressurize the vessel.

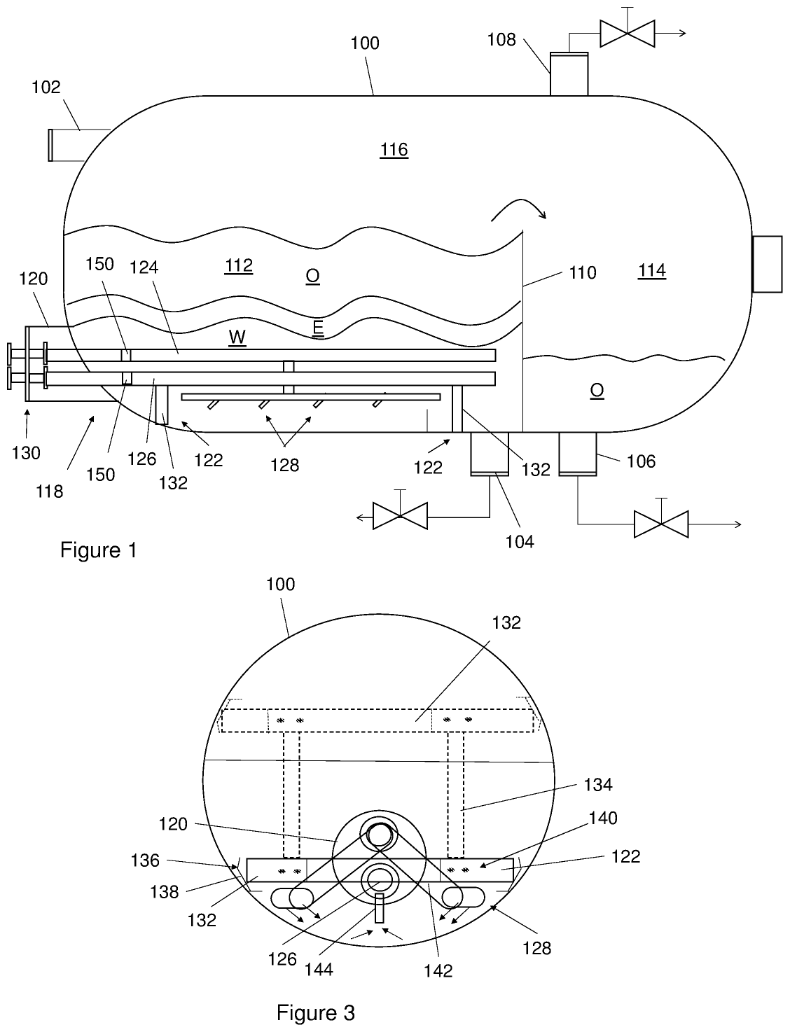

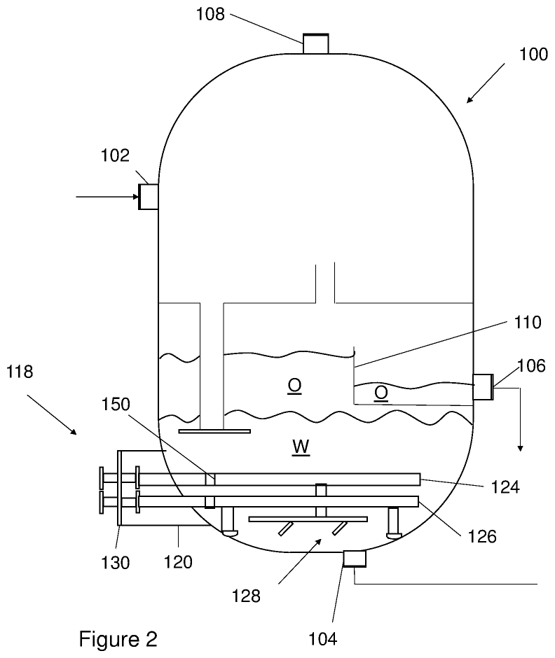

Referring now to FIG. 1, a vessel separator 100 is shown having a process fluid inlet 102, a water outlet 104, an oil outlet 106, and a gas outlet 108. As shown, the vessel separator 100 may be a FWKO drum positioned horizontally. In some embodiments, the vessel separator 100 may be a test separator positioned horizontally. However, in other embodiments, the vessel separator may be a vessel (e.g., FWKO drum or test separator) vertically positioned, as shown in FIG. 2 where like numbers represent like elements. Referring still to FIG. 1, a weir 110 is disposed inside the vessel and separates the vessel into two compartments, a first compartment 112 and a second compartment 114. As shown, the weir 110 may be a vertical plate positioned within the vessel separator 100. The weir 110 may be positioned at any location along a length of the vessel separator 100. In some embodiments, the weir 110 may be positioned closer to one end of the vessel separator 100, as shown in FIG. 1. The weir 110 may be coupled to the vessel separator 100 by any means known in the art, such as by welding, to create a sealed separation between the first compartment 112 and the second compartment 114.

A process fluid enters the vessel separator 100 through the fluid inlet 102. The fluid settles in the vessel separator 100 on one side of the weir 110, i.e., in first compartment 112. As the fluid settles, gases may escape into an upper area of the vessel, the vapor space 116, and may exit through the gas outlet 108. Over time, the water W and oil O separate, as shown in FIG. 1, with the water W settling to the bottom of the first compartment 112 and the oil O settling on top of the water W. An emulsion layer E of mixed oil and water may form between the water W and the oil O layers. The separated water W may exit through the water outlet 104 located in the first compartment 112 on a first side of the weir 110. As the height of the fluid in the first compartment 112 increases, due to the addition of additional process fluid or water, oil O that has settled above the water W layer spills over the weir 110 into the second compartment 114 on a second side of the weir 110. Oil O may then exit the vessel separator 100 through the oil outlet 106.

As further shown in FIG. 1, the vessel separator 100 may include a solids removal system 118 in accordance with one or more embodiments of the present disclosure. The solids removal system 118 is configured to be installed in the vessel separator 100 through manway 120. Advantageously, solids removal system 118 may be installed in an existing vessel separator without physically modifying the vessel separator itself.

Generally, the solids removal system 118 includes an adjustable support structure 122 for installation in the vessel separator 100, a supply header 124 for providing a flow of fluid into the vessel separator 100, and a return header 126 for removing a fluidized solids from the vessel separator 100. The solids removal system also includes at least one jetting nozzle 128 in fluid communication with the supply header 124 for providing a jetted fluid to the vessel separator 100 to fluidize accumulated solids therein. The solids removal system 118 further includes a manway cover 130 configured to couple to the manway 120 of the new or existing vessel separator 100 and to allow for fluid to be provided through the manway cover 130 into the supply header 124 and out from the return header 126. Therefore, the manway cover 130, once installed, allows for fluid communication through the manway 120 while maintaining pressurization of the vessel separator 100.

Still referring to FIG. 1, the adjustable support structure 122 is configured to be installed and secured within the vessel separator 100. The support structure 122 is installed within the vessel separator 100 and provides a base on which the supply header 124 and the return header 126 may be secured within the vessel separator. The support structure 122 may include one or more crossbeams 132 secured between the walls of the vessel separator 100. As shown in FIG. 1, two or more crossbeams 132 may be positioned along a length of the vessel separator 100 to support a length of the supply header 124 and the return header 126. In some embodiments, the support structure 132 may also include two or more crossbeams 132 positioned one above the other as shown in FIG. 3 (optional upper crossbeams indicated by dashed line). In such an embodiment, one or more vertical support beams 134 may be positioned between crossbeams 132 positioned above one another.

As shown in FIGS. 1 and 3, the support structure 122 (e.g., crossbeams 132) is not fastened to the vessel separator 100 by mechanical fasteners, welding, bonding, or any other means that would require modification to the vessel separator itself. Rather, the support structure 122 may be braced between the wall of the vessel separator 100 or other components already disposed within the vessel separator 100, such as a wave breaker baffle. More specifically, as shown in greater detail in FIG. 3, a bracket 136 may be coupled to a first end and a second end of the crossbeam 132 by, for example, mechanical fasteners or welding. The bracket 136 may include a contact surface 138 on an outer surface thereof that is configured to engage with the wall of the vessel separator 100. In one embodiment, the contact surface 138 of the bracket 136 may curved to correspond with a curvature of an inner surface of the wall of the vessel separator 100. For example, in one or more embodiments, the contact surface 138 may include a convex curvature. The contact surface 138 of the bracket 136 allows the bracket 136, and therefore the crossbeam 132, to frictionally engage the wall of the vessel separator 100. Thus, as the crossbeam 132 is positioned within the vessel separator 100, the two brackets 136 (one at the first end and one at the second end of the crossbeam 132) frictionally engage with the wall of the vessel separator 100 and brace or wedge the crossbeam 132 between the vessel wall. In some embodiments, a radius of curvature of the contact surface 138 may be approximately equal to a radius of curvature of the inner surface of the vessel separator 100. In other embodiments, the radius of curvature of the contact surface 138 may be greater than the radius of curvature of the inner surface of the vessel separator 100.

As discussed above, vertical support beams 134 may be coupled between crossbeams 132 positioned vertically above each other to further secure the solids removal system 118 within the vessel separator 100. In some embodiments, vertical support beams 134 may be used to secure a crossbeam 132 to another component already installed within the vessel separator 100. For example, in one or more embodiments, a lower end of vertical support beam 134 may be coupled to a crossbeam 132 disposed in a lower portion of the vessel separator 100. In this embodiment, an upper end of the vertical support beam 134 may be coupled to, for example, a wave breaker baffle that is already installed in the vessel separator 100. Coupling the crossbeam 132 to another component of the vessel separator 100, such as the wave breaker baffle may also help raise the adjustable support structure 122 off of a bottom of the vessel separator 100. Coupling of the crossbeam 132 to the vertical support beam 134 and of the vertical support beam 134 to the other component of the vessel separator 100 (e.g., the wave breaker baffle) may be provided by mechanical fasteners, welding, bonding, or other methods known in the art.

A length of the crossbeam 132 of the vertical support beam 134 is adjustable to assist in providing a tight fit between the crossbeam 132 and the wall of the vessel separator 100. For example, as shown in FIG. 3, crossbeam 132 may include 2 or more segments slidingly engaged with one another. Each segment may be extended or retracted to achieve a desired length of the crossbeam. A locking mechanism 140 may be coupled through two adjacent segments to secure the segments in a determined position providing the desired length of the crossbeam. In one or more embodiments, the locking mechanism 140 may be a bolt, a screw, a locking pin, or other locking devices known in the art.

Still referring to FIGS. 1 and 3, the supply header 124 and the return header 126 may be coupled to the support structure 122. The supply header 124 and return header 126 may be coupled to the support structure 122 by any means known in the art. For example, in one or more embodiments, the supply header 124 and return header 126 may be coupled to the support structure using one or more brackets, framework, support beams, etc. The supply header 124 and the return header extend a length of the vessel separator 100 from an end proximate the manway 120 located on a water side of the weir 110 to a location proximate the weir 110. The supply header 124 is configured to receive a flow of fluid (e.g., produced water) from outside the vessel separator 100 and supply the fluid to one or more jetting nozzles 128 disposed in the vessel separator 100.

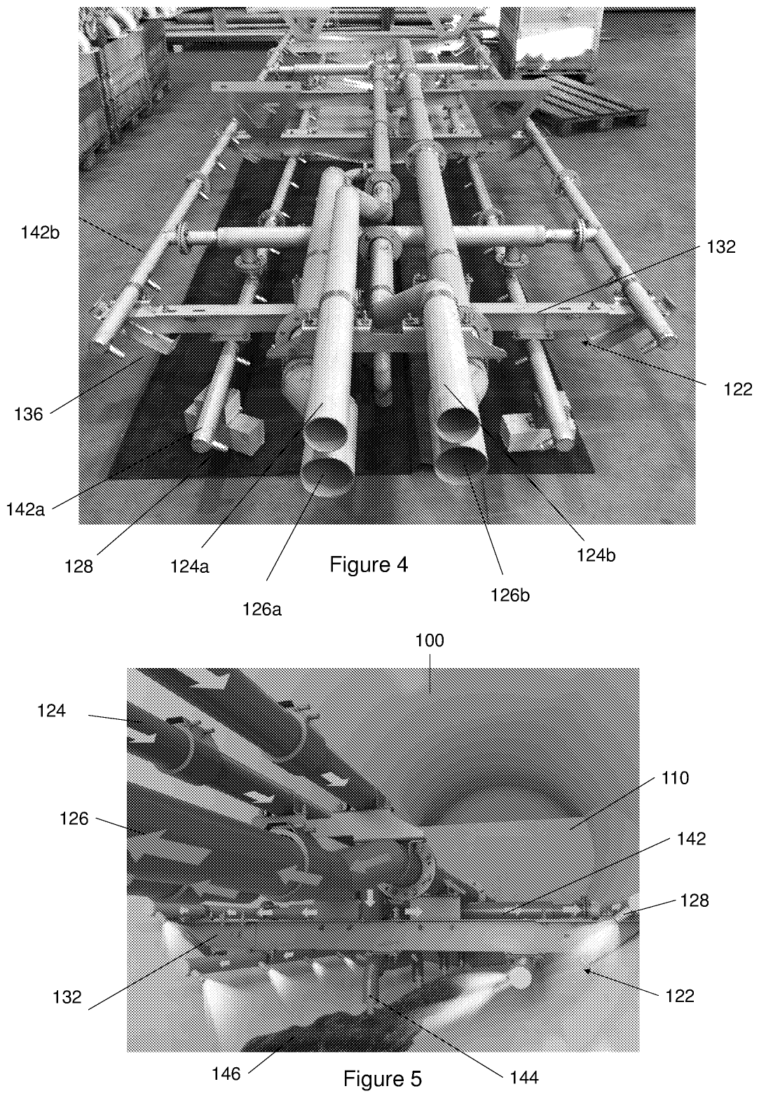

FIG. 4 shows an example of the supply header 124 and the return header 126 coupled to the support structure 122 without the vessel separator for illustration purposes. In one or more embodiments, the solids removal system 118 may include two or more supply headers 124 and two or more return headers 126. In some embodiments, a first supply header 124a may have a shorter length than a second supply header 124b. Similarly, a first return header 126a may have a shorter length than a second return header 126b. In this embodiment, the fluid may be supplied to the vessel and the fluidized solids removed from the system in zones. In other words, the first supply header 124a and the first return header 126a operate to clean a first zone of the first compartment of the vessel separator, and the second supply header 124b and the second return header 126b operate to clean a second zone of the first compartment of the vessel separator. Different embodiments may be based on the same principle applied to any multitude of zones.

With reference to FIGS. 1, 3, and 4 together, in one or more embodiments, one or more additional flow lines 142 may be coupled to the supply header 124 and coupled to the support structure 122. The one or more flow lines 142 may extend radially from the supply header 124 out towards the wall of the vessel separator 100 and/or along a length of the separator vessel 100. The one or more flow lines 142 are in fluid communication with the supply header 124 and direct fluid flow from the supply header 124 to the jetting nozzle(s) 128. A number of flow lines 142 may be connected to the supply header 124 and/or interconnected with other flow lines 142 to provide a network of flow lines along and across the bottom of the vessel separator 100. The design of the network of flow lines 142 may vary depending on, for example, the size of the vessel separator 100 and the number of jetting nozzles 128. In one or more embodiments, a flow line 142a may be positioned below and radially inward of a second flow line 142b, as shown in FIG. 4. The flow lines 142 may be positioned at different locations in accordance with the curved shape of the bottom of the vessel separator 100.

The at least one jetting nozzle 128 may be coupled to the one or more flow lines 142 so that fluid supplied to the vessel separator 100 flows through the supply header 124, into the one or more flow lines 142, and out the at least one jetting nozzle 128 to provide a jetted fluid to an inner surface of the vessel separator 100. Any jetting nozzle known in the art may be used in accordance with embodiments disclosed herein. As shown in FIG. 4, the at least one jetting nozzle 128 may be angled downward and radially inward to direct the fluidized solids toward the return header 126.

The return header 126 is configured to suction up the fluidized solids (e.g., slurry) from the bottom of the vessel separator 100 and flow the fluidized solids out of the vessel separator 100 through the manway 120. As shown in FIG. 3, one or more suction nozzles 144 may be coupled to a lower end of the return header 126 and extend vertically downward toward the bottom of the vessel separator 100. The suction nozzles 144 suction the fluidized solids 146 (e.g., slurry) out from the bottom of the vessel separator 100 into the return header 126, where it is flowed out of the vessel separator 100.

FIG. 5 shows a schematic of the supply headers 124, return headers 126, flow lines 142, and jetting nozzles 128 as used to fluidize accumulated solids and suction the fluidized solids back up. As show, the fluid (e.g., water) flows through the supply headers 124, through the flow lines 142, and jetted out of the jetting nozzles 128 to fluidize the solids and move the fluidized solids 146 toward the suction nozzles 146. The suction nozzles 144 suction the fluidized solids 146 into the return header 126 which then directs the fluidized solids 146 out of the vessel separator 100.

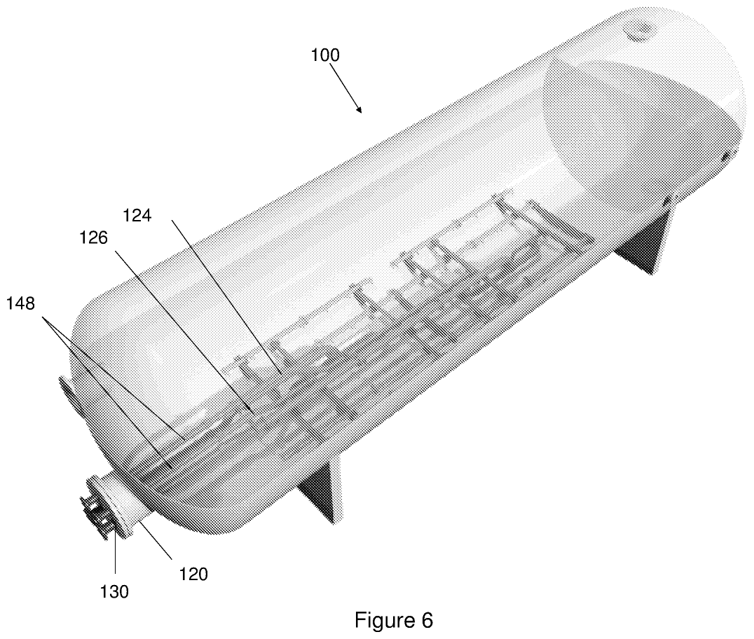

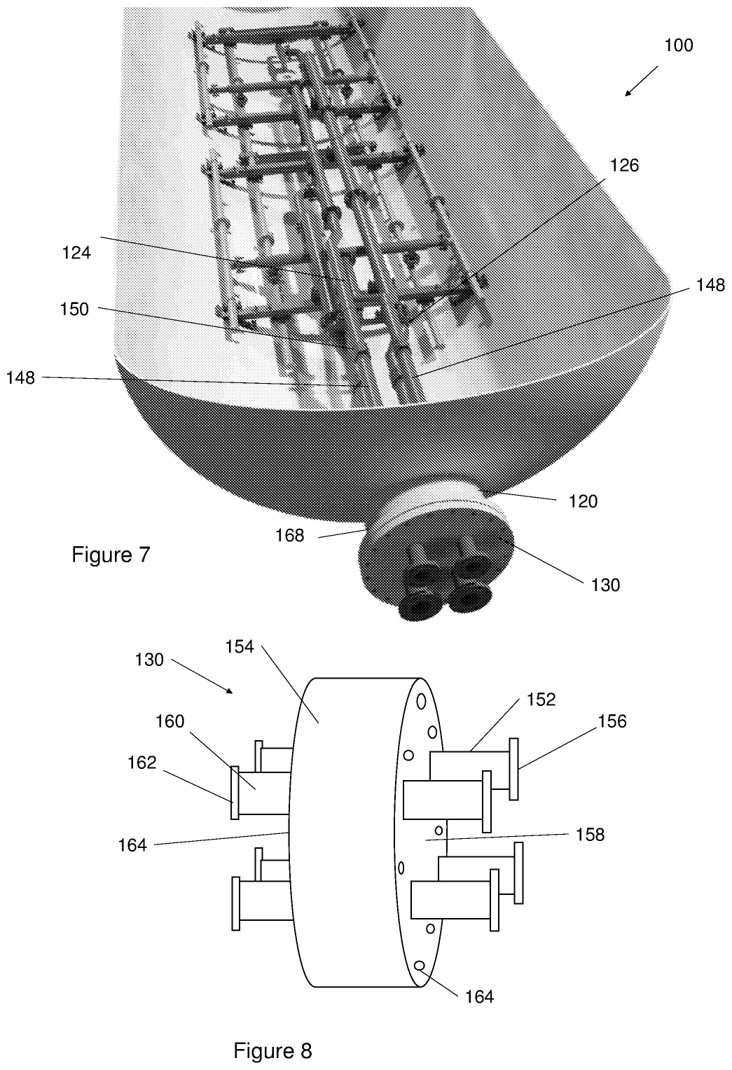

FIG. 6 shows the vessel separator 100 having the jetting system 118 installed therein. As shown, the supply headers 124 and the return headers 126 are each coupled to a connecting pipe 148 extending from the manway 102. Although FIG. 6 shows two supply headers 124, two return headers 126, and therefore four connecting pipes 148, in one or more embodiments, the vessel separator 100 may include only one supply header 124 coupled to one connecting pipe 148, and one return header 126 connected to one connecting pipe 148. FIG. 7 shows an end perspective view of the vessel separator 100 shown in FIG. 6. As seen in FIG. 7, each supply header 124 is coupled to the corresponding connecting pipe 148 with a pipe clamp 150. The pipe clamp 150 may mechanically fasten a proximal end of the supply header 124 with a distal end of the corresponding connecting pipe 148 and a proximal end of the return header 126 with a distal end of the corresponding connecting pipe 148. The connecting pipes 148 are connected to nozzles provided in the manway cover 130 to provide a fluid connection with the connecting pipes 148 so that fluid may flow in to the supply headers 124 from outside the vessel separator 100 and flow from the return headers 126 out of the vessel separator 126.

As shown in more detail in FIG. 8, the manway cover 130 is a modified blind flange having two or more nozzles 152. Specifically, the manway cover 130 includes a blind flange 154 having at least two openings through which fluid may flow. A nozzle 152 having a flange 156 is welded to an interior side 158 of the blind flange 154 at each opening location. Similarly, a nozzle 160 having a flange 162 is welded to an exterior side 164 of the manway cover 130 at each opening location. Although FIG. 8 shows 4 nozzles on each side of the manway cover 130, in one or more embodiments, the manway cover 130 may have only two openings and therefore only two nozzles on each side of the manway cover 130. Such an embodiment is used when the solids removal system only includes one supply header and one return header. In some embodiments a return header is not applicable, for example, if there are existing drain nozzles available that are suitable for removing the fluidized solids. For such cases the additional nozzles on the manway cover would be limited to one or more water supply nozzles. A plurality of bolt holes 166 is provided around a peripheral edge of the manway cover 130 that align with corresponding bolt holes (not shown) of a flange 168 (FIG. 7) on the manway 120 (FIG. 7). A gasket (not shown) may be provided between the manway cover 130 and the flange 168 of the manway to ensure a fluid tight seal upon makeup.

Referring to FIGS. 7 and 8 together, each connecting pipe 148 is connected to a corresponding flange 156 and nozzle 152 on the interior side 158 of the manway cover 130 after the manway cover 130 is coupled to the manway 120. Thus, once the solids removal system is installed, the jetting system components inside the vessel separator are in fluid communication with components outside the vessel separator through the manway cover 130. Thus, the solids removal system 118 in accordance with embodiments disclosed herein provides a system and method for on-line solids removal. In other words, the solids removal system disclosed herein provides a system and method for removal of solids from a vessel separator without having to take the vessel offline or depressurize it, once the solids removal system has been installed.

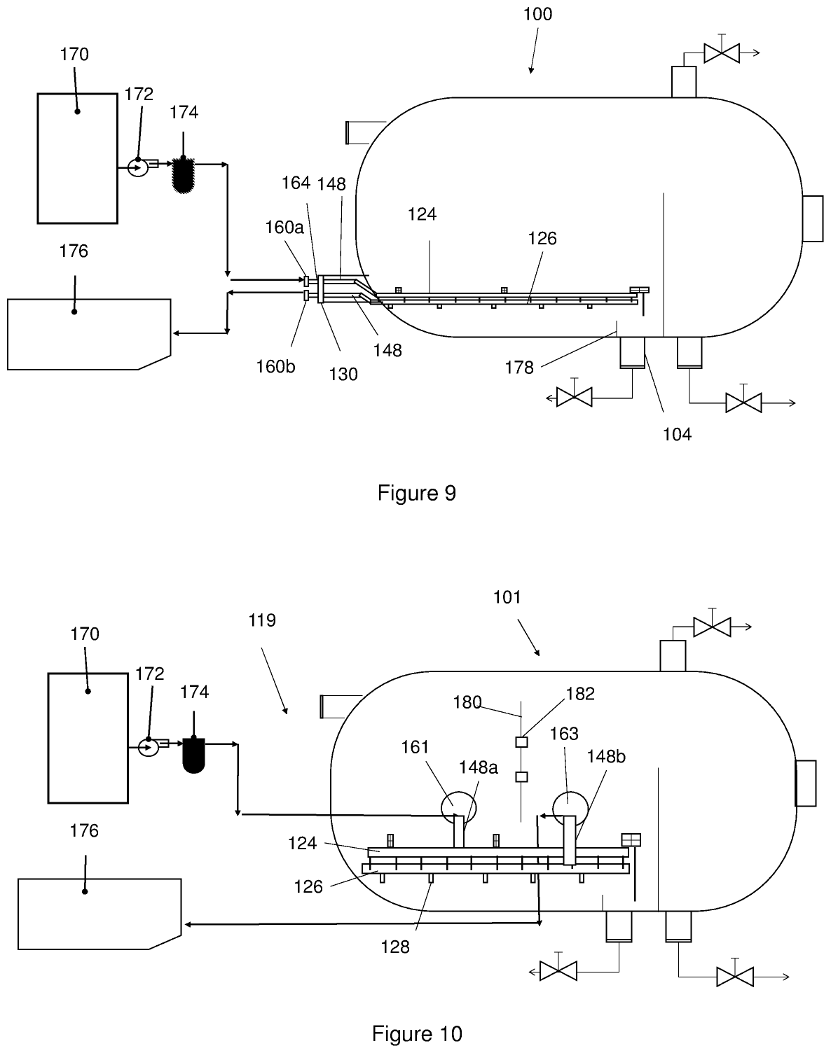

As shown in FIG. 9, a fluid tank 170 containing, for example, a produced water, is in fluid communication with an inlet nozzle 160a on the exterior side 164 of the manway cover 130. A pump 172 pumps water through a flow line to the inlet nozzle 160a. In one or more embodiments, a filter 174 may be provided in line with the flow line from the pump 172 to the inlet nozzle 160a. Fluid flows through the inlet nozzle 160a through the manway cover 130, through the connecting pipe 148 and into the supply header 124. From the supply header 124, fluid is then flowed out through at least one nozzle (128, FIG. 5) and into the bottom of the vessel separator 100. The jetted fluid fluidizes solids accumulated within the vessel separator 100. A solids level detection probe may be installed in the vessel separator to determine a level of solids accumulated in the vessel separator 100.

As discussed above, the vessel separator 100 in accordance with embodiments disclosed herein is a pressure vessel. Further, due to the design of the solids removal system disclosed herein, the vessel separator 100 may remain on-line, and therefore pressurized, during solids removal using the solids removal system. In accordance with one or more embodiments disclosed herein, for on-line solids removal, approximately 200 GPM of fluid at approximately 60 psi above an operating pressure of the vessel separator may be provided at the inlet nozzle 160a to provide the necessary fluid flow through the supply header 124 and the one or more nozzles 128. Those skilled in the art will appreciate that the appropriate amount of fluid flow and pressure may be determined and/or selected for any specific embodiment of a solids removal system. The vessel operating pressure provides for suction in the one or more suction nozzles (144, FIG. 5) coupled to the return header 126. Accordingly, fluidized solids is suctioned up through the suction nozzles (144, FIG. 5), flows through the return header 126 and the corresponding connecting pipe 148 and out the manway cover 130 through the outlet nozzle 160b. In other embodiments, fluidized solids are drained through existing drain nozzles in the bottom of the separator. In some embodiments, a solids dam 178 may be installed in the bottom of the vessel separator to prevent fluidized solids from exiting the water outlet 104. In one embodiment, the solids dam 178 may be a vertical plate connected to the bottom of the vessel separator near the water outlet 104. Fluid exiting the solids removal system may be flowed to a solids slurry tank 176. Thus, a solids removal system in accordance with embodiments disclosed herein allows for fluids to be pumped into and a slurry extracted out of a pressurized vessel separator for solids removal without the need to depressurize the vessel.

While embodiments described above describe jetting nozzles, one or more embodiments for solids removal systems in accordance with the present application may include cyclonic devices. For cyclonic solids removal systems the same principles described above apply. Specifically, cyclonic solids removal systems include a supply header where water is pumped into the cyclonic device, solids are fluidized, and a slurry is extracted out of the vessel. In other words, the manway cover 130 as described herein may be used with a cyclonic solids removal system in a pressurized separator vessel to provide the additional nozzles needed to route the water supply and slurry extraction through the pressure vessel without modification of the pressure vessel itself.

A method of retrofitting an existing vessel separator with a solids removal system in accordance with embodiments disclosed herein may include installing a support structure in the vessel separator, the support structure being provided to support at least one supply header and at least one return header. For installation of the solids removal system, the vessel separator must initially be taken off line and depressurized and vented. A manway of the vessel separator is opened and the support structure is placed inside the vessel separator. As discussed above, the support structure may be adjustable such that the size (e.g., length) of one or more crossbeams and one or more vertical support beams may be varied. For example, the length of a crossbeam may be lengthened to move contact surfaces of brackets on the ends of the crossbeams move into frictional engagement with the wall of the vessel separator. Thus, the crossbeams may be braced between the vessel walls or between the vessel walls and/or other internal components of the vessel separator, such as a wave breaker baffles.

The supply header and return header may also be assembled and installed. One or more flow lines may be assembled and installed, including coupling the flow lines to the supply header, as described above. At least one jetting nozzle is installed in fluid communication with the supply header. One of ordinary skill in the art will appreciate that the support structure, the supply header, the return header, one or more flow lines, and at least one jetting nozzle may be assembled inside the vessel separator, or in some embodiments, may be assembled outside the vessel separator and then installed and adjusted as needed inside the vessel. The manway cover having at least one nozzle may be secured to the manway of vessel separator. A second manway, located, for example on an opposite end of the vessel separator from the manway with the manway cover having at least one nozzle, provides access to the interior of the vessel separator to complete assembly of the solids removal system. In accordance with embodiments disclosed herein, at least one connecting pipe may be connected to the at least one nozzle on the manway cover before or after assembly of the manway cover to the manway. The supply header and the return header are then coupled to the corresponding connecting pipes using, for example pipe clamps.

Referring now to FIG. 10, a solids removal system 119 in accordance with one or more embodiments is shown. FIG. 10 shows a test separator 101 that is similar to the vessel separators shown in FIG. 9. However, the test separator 101 is generally a smaller pressure vessel than for example the FWKO drum shown in FIGS. 1 and 9. Due to its size, it is not possible for a person to reach the manway located on the opposite side of the vessel. Therefore, modification of the manway covers of the test separator 101 may not be possible. Accordingly, the solids removal system 119 provides another way of coupling the supply header 124 to the fluid tank 170 and the return header 126 to the solids slurry tank 176. Other features of the solids removal system 119 not specifically described here may be provided in accordance with one or more embodiments discussed above with respect to FIGS. 1-9. As shown in FIG. 10, the supply header 124 and the return header 126 are installed on support structure (as describe with respect to FIGS. 1-9) in the test separator 101. Similarly, jetting nozzles 128 in fluid communication with the supply header provide for a jetted fluid to be introduced into the test separator to fluidize solids accumulated therein for removal by the return header 126.

According to one or more embodiments, the test separator 101 includes two or more size openings or nozzles in the wall of the test separator 101. In accordance with embodiments of the present disclosure two nozzles in the wall of the test separator 101 may be used to provide a fluid inlet to the supply header 124 and an outlet from the return header 126. While the test separators 101 may include additional unused nozzles that may be used as a fluid inlet and fluid outlet, in one or more embodiments, nozzles that are used to house zinc anodes for corrosion prevention may be repurposed as a fluid inlet and fluid outlet. For example, in one or more embodiments, these anodes 182 may be re-located and installed on the wave breaker baffle 180.

As shown in FIG. 10, the wall of the test separator 101 includes a first nozzle that will be used as an inlet nozzle 161. A connecting pipe 148a connects the supply header 124 to the inlet nozzle 161 so that fluid may be provided from the fluid tank 170 to the supply header 124. A second nozzle on the wall of the test separator 101 will be used as an outlet nozzle 163. A connecting pipe 148b connects the return header 126 to the outlet nozzle 163 so that the fluidized solids may be provided from the return header 126 to the solids slurry tank 176. In accordance with one or more embodiments, a flange 154 as shown in FIG. 8 may be coupled to the first nozzle and the second nozzle on the wall of the test separator 101. For example, a first flange 154 as shown in FIG. 8 may include a single opening through which fluid may flow and, therefore, a single nozzle 152 having a flange 156 on the interior side 158 and a single nozzle having a flange 162 on the exterior side 164. The flange 154 be coupled (e.g., by bolting) to the first nozzle on the wall of the test separator 101. A second flange also having a single opening through which fluid may flow and, therefore, a single nozzle having flange on an interior side and a single nozzle having a flange on exterior side may be coupled to the second nozzle on the wall of the test separator 101. Referring to FIGS. 8 and 10, the connecting pipes 148a and 148b may thus be connected to the single nozzles of the first and second flanges, and the flanges coupled to existing nozzles or openings in the wall of the test separator.

As shown in FIG. 10, a fluid tank 170 containing, for example, a produced water, is in fluid communication with the inlet nozzle 161 on the wall of the test separator 101. A pump 172 pumps water through a flow line to the inlet nozzle 161. In one or more embodiments, a filter 174 may be provided in line with the flow line from the pump 172 to the inlet nozzle 161. Fluid flows through the inlet nozzle 161, through the connecting pipe 148a and into the supply header 124. From the supply header 124, fluid is then flowed out through at least one nozzle (128, FIG. 5) and into the bottom of the test separator 101. The jetted fluid fluidizes solids accumulated within the test separator 101. A solids level detection probe may be installed in the test separator to determine a level of solids accumulated in the test separator 101.

As discussed above, the test separator 101 in accordance with embodiments disclosed herein is a pressure vessel. Further, due to the design of the solids removal system disclosed herein, the test separator 101 may remain on-line, and therefore pressurized, during solids removal using the solids removal system. In accordance with one or more embodiments disclosed herein, for on-line solids removal, approximately 56 GPM of fluid at approximately 50 psi above an operating pressure of the vessel separator may be provided at the inlet nozzle 161 to provide the necessary fluid flow through the supply header 124 and the one or more nozzles 128. Those skilled in the art will appreciate that the appropriate amount of fluid flow and pressure may vary based on a specific embodiment of a solids removal system, and therefore, may be determined for each application. The vessel operating pressure provides for suction in the one or more suction nozzles (144, FIG. 5) coupled to the return header 126. Accordingly, fluidized solids are suctioned up through the suction nozzles (144, FIG. 5), flow through the return header 126 and the corresponding connecting pipe 148b and out the test separator 101 through the outlet nozzle 163. In other embodiments, fluidized solids are drained through existing drain nozzles in the bottom of the separator. In some embodiments, a solids dam 178 may be installed in the bottom of the vessel separator to prevent fluidized solids from exiting the water outlet 104. Thus, a solids removal system 119 in accordance with embodiments disclosed herein allows for allows for fluids to be pumped into and a slurry extracted out of a pressurized vessel separator for solids removal without the need to depressurize the vessel.

A method of retrofitting an existing test separator with a solids removal system in accordance with embodiments disclosed herein may include installing a support structure in the test separator, the support structure being provided to support at least one supply header and at least one return header. For installation of the solids removal system, the vessel separator must initially be taken off line and depressurized and vented. A manway of the vessel separator is opened and the support structure is placed inside the vessel separator. As discussed above, the support structure may be adjustable such that the size (e.g., length) of one or more crossbeams and one or more vertical support beams may be varied. For example, the length of a crossbeam may be lengthened to move contact surfaces of brackets on the ends of the crossbeams move into frictional engagement with the wall of the vessel separator. Thus, the crossbeams may be braced between the vessel walls or between the vessel walls and/or other internal components of the vessel separator, such as a wave breaker baffles.

The supply header and return header may also be assembled and installed. One or more flow lines may be assembled and installed, including coupling the flow lines to the supply header, as described above. At least one jetting nozzle is installed in fluid communication with the supply header. The connecting pipe 148a is installed in the inlet nozzle 161 and the connecting pipe 148b is installed in the outlet nozzle 163. One of ordinary skill in the art will appreciate that the support structure, the supply header, the return header, one or more flow lines, and at least one jetting nozzle may be assembly inside the test separator, or in some embodiments, may be assembled outside the test separator and then installed and adjusted as needed inside the vessel. A manway may provide access to the interior of the vessel separator to finish assembly of the solids removal system. The supply header 124 and the return header 126 are then coupled to the corresponding connecting pipes 148a, 148b using, for example pipe clamps.

A method of retrofitting in accordance with embodiments disclosed herein allows for a vessel separator to be modified to include a solids removal system without having to modify the vessel separator in a way that would require recertification of the vessel. Further, retrofitting a vessel separator in accordance with embodiments disclosed herein allows for a vessel separator to be modified to include a solids removal system that, once installed, can be operated on-line without having to depressurize the vessel system. For example, once installed, the solids removal system can be operated daily, weekly, or other desired times without having to depressurize or disconnect the separator pressure vessel from the system.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

1. A method of retrofitting an existing separator pressure vessel with a solids removal system, the method comprising:
installing a support structure in the separator pressure vessel;
adjusting a size of the support structure within the separator pressure vessel to frictionally engage contact surfaces of the support structure with an inner surface of the separator pressure vessel or a surface of a component installed in the separator pressure vessel;
installing a supply header and a suction header on the support structure in the separator pressure vessel;
coupling a jetting nozzle or a cyclonic device to the supply header;
coupling the supply header to an inlet nozzle extending from an interior of the separator pressure vessel to an exterior of the separator pressure vessel; and
coupling the return header to an outlet nozzle from an interior of the separator pressure vessel to an exterior of the separator pressure vessel.

2. The method of claim 1, further comprising installing the inlet nozzle and the outlet nozzle in a flange configured to be coupled to an existing nozzle on the separator pressure vessel.

3. The method of claim 2, further comprising installing the flange having the inlet nozzle and the outlet nozzle on a manway of the separator pressure vessel.

4. The method of claim 1, wherein the inlet nozzle and the outlet nozzle are nozzles formed on a wall of the separator pressure vessel.

5. The method of claim 1, further comprising providing a flow of fluid into the separator pressure vessel through the supply header and a flow of slurry through the return header and out of the separator pressure vessel while a pressure inside the separator pressure vessel is maintained.

6. The method of claim 1, further comprising coupling a connecting pipe between the inlet nozzle and supply header, and coupling a connecting pipe between the outlet nozzle and the return header.

7. The method of claim 1, further comprising coupling a fluid tank to the inlet nozzle and a slurry tank to the outlet nozzle.

8. The method of claim 1, further comprising coupling a fluid tank to the inlet nozzle and a slurry tank to the outlet nozzle.

9. The method of claim 1, wherein the component installed in the separator pressure vessel is a wave breaker baffle.

10. The method of claim 8, further comprising positioning at least one zinc anode on the wave breaker baffle.

11. A solids removal system comprising:
a support structure;
a supply header coupled to the support structure;
a jetting nozzle in fluid communication with the supply header;
a return header coupled to the support structure; and
a flange comprising:
an inlet nozzle extending through the flange, a first end of the inlet nozzle configured to couple with a first end of the supply header; and
an outlet nozzle extending through the flange, a first end of the outlet nozzle configured to couple with a first end of the suction header.

12. The solids removal system of claim 11, further comprising a second supply header having a length longer than the supply header and a second return header having a length longer than the return header.

13. The solids removal system of claim 11, wherein a size of the support structure is adjustable.

14. The solids removal system of claim 11, further comprising a solids dam.

15. The solids removal system of claim 11, wherein the flange comprises a blind flange having two openings therethrough.

16. A separator pressure vessel system comprising:
a weir extending up from a bottom of the separator pressure vessel;
an adjustable support structure removably disposed within the separator pressure vessel on a first side of the weir, the support structure comprising at least two contact surfaces configured to frictionally engage an inner surface of the separator pressure vessel or a component installed in the separator pressure vessel;
a supply header coupled to the adjustable support structure;
a jetting nozzle or cyclonic device in fluid communication with the supply header;
a suction header disposed in the separator pressure vessel and coupled to the support structure;
an inlet nozzle extending from an interior of the separator pressure vessel to an exterior of the separator pressure vessel, wherein the inlet nozzle is coupled to the supply header; and
an outlet nozzle extending from an interior of the separator pressure vessel to an exterior of the separator pressure vessel, wherein the outlet nozzle is coupled to the return header.

17. The separator pressure vessel system of claim 16, wherein the inlet nozzle and the outlet nozzle are coupled to a flange.

18. The separator pressure vessel of claim 16, wherein the inlet nozzle and the outlet nozzle are formed in the wall of the separator pressure vessel.

19. The separator pressure vessel of claim 16, further comprising a fluid tank in fluid communication with the inlet nozzle.

20. The separator pressure vessel of claim 16, further comprising a slurry tank in fluid communication with the outlet nozzle.

21. The separator pressure vessel of claim 16, further comprising a solids dam disposed in the bottom of the separator pressure vessel proximate a water outlet.
